(19) United States
(12) Patent Application Publication
(10) Pub. No.: US 2009/0094807 A1
(43) Pub. Date: Apr. 16, 2009

(54) Seatbelt buckle apparatus

(75) Inventors: Shinichi Sugimoto, Tokyo (JP); Koji Tanaka, Tokyo (JP); Hiroshi Nozu, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: TAKATA CORPORATION, Tokyo (JP)

(21) Appl. No.: 12/285,653

(22) Filed: Oct. 10, 2008

(30) Foreign Application Priority Data
Oct. 16, 2007 (JP) 2007-269071
Sep. 1, 2008 (JP) 2008-223286

(51) Int. Cl. B60R 22/48

(52) U.S. Cl. 24/589.1; 701/45

(57) ABSTRACT

A seatbelt buckle apparatus for attaching a tongue of a seatbelt includes a buckle projection mechanism having a buckle therein, to which the tongue of the seatbelt is to be inserted, a seating detection portion, and a load transmission-driving device. The buckle projection mechanism locates the buckle inside a seat when an occupant is not seated, and to stand up from the seat when the occupant is seated. The seating detection portion is housed in the seat at a seating position of the occupant and detects a load of the occupant. The seating detection portion has a supporting member. The load transmission-driving device transmits a displacement amount of the supporting member, generated in the seating detection portion when the occupant is seated, to the buckle projection mechanism, and drives the buckle projection mechanism so that the tongue can be inserted into the buckle when the occupant is seated.

### BACKGROUND OF THE INVENTION AND RELATED ART STATEMENT

The present invention relates to a seatbelt buckle apparatus, and more specifically, it relates to a seatbelt buckle apparatus, in which in a rear seat of a vehicle or the like, a buckle is usually housed in an inside of a seat or a seat back, and an occupant can easily insert a tongue of a seatbelt into the buckle by causing the buckle to stand up from a seating surface, or by projecting the buckle from a seat back when the occupant is seated and wears the seatbelt.

From Jun. 1, 2008 in Japan, an occupant seated in a rear seat of an automobile is legally obliged to wear a seatbelt. In general, since many of the rear seats are formed of a bench seat-type seat, different from a seatbelt apparatus of a driver's seat and a passenger's seat, a seatbelt apparatus having a self-sustaining structure, in which a buckle apparatus projects form a seating surface, has not been virtually adopted. Specifically, in the rear seat of the bench seat type, since the occupant gets on a vehicle from a door at one side thereof, and sometimes moves widthwise while being seated, in the structure of the seatbelt apparatus where the buckle apparatus is projected from the seating surface, usability is not good. Therefore, in general, many of the seatbelt buckle apparatuses have a structure in which the buckle apparatus is held on a base portion via soft webbing so that the buckle apparatus is positioned in a clearance between a seating portion and a lower end of a back portion.

Further, different from a driver seat, since a rear seat occupant is seated on various positions, it is difficult to look for a position of the buckle apparatus that is positioned between the seating portion and the lower end of the back portion, and the occupant should sometimes look for the buckle apparatus. In order to save such a trouble as looking for the buckle apparatus, a seatbelt apparatus where the buckle moves between the time when the seatbelt is worn and the time when the seatbelt is not worn is developed. For example, there is a seatbelt apparatus where a buckle is moved via a motor so that a seatbelt tongue insertion hole of the buckle is positioned at a place higher than a seating surface of a seat when a seatbelt is not worn, and that the seatbelt tongue insertion hole of the buckle is positioned at a place lower than the seating surface of the seat when the seatbelt is worn, upon detecting of wearing of the seatbelt by a sensor (refer to Japanese Unexamined Utility Model Publication No. 6-83514).

In the seatbelt apparatus disclosed in the above publication, in a case that seats are separated by a center console or the like as is seen in a one-person seat at a front seat, since a buckle apparatus is disposed at a side surface of the seat, there is no possibility for a buckle to come into contact with a body of an occupant. However, in a rear seat of a bench seat type, there has been a problem such that the occupant has seated on the buckle apparatus when the seatbelt is not yet worn, or that the buckle apparatus, which is not used, comes into contact with the body, and therefore a comfortable seating state cannot be kept.

Furthermore, in the seatbelt apparatus disclosed in the above publication, a judgment whether the buckle apparatus is moved to a predetermined position or not is performed by detecting presence or absence of wearing of the seatbelt upon adopting an electric sensor. Moreover, since a motor is used for moving the buckle, there is also a demand to make the same operation at an inexpensive equipment cost.

Consequently, an object of the present invention is to provide a seatbelt buckle apparatus configured such that the above-described problems are solved, and that an inserting operation of a tongue can easily be performed by means of projecting the buckle apparatus from a seating surface of the seat or a seat back surface without intervening an actuator such as a motor or the like, after the occupant is seated in the seat without using an electric detecting device.

Further objects and advantages of the invention will be apparent from the following description of the invention.

### SUMMARY OF THE INVENTION

In order to achieve the above-described object, the present invention includes a buckle projection mechanism housing a buckle, into which a tongue of a seatbelt may be inserted, in an inside of a seating portion when an occupant is not seated, and causing the buckle to stand up from the inside of the seating portion when the occupant is seated; a seating detection portion detecting a load of the occupant, which is housed in a seat at a seating position of the occupant via a supporting member; and a load transmission-driving device transmitting a displacement amount of the supporting member, generated in the seating detection portion when the occupant is seated, to the buckle projection mechanism, and driving the buckle projection mechanism, and enabling the tongue to be inserted into the buckle when the occupant is seated.

The present invention may include a buckle projection mechanism housing a buckle, into which a tongue of a seatbelt may be inserted, in an inside of a seat back when an occupant is not seated, and causing the buckle to project from the inside of the seat back when the occupant is seated; a seating detection portion detecting a load of the occupant, which is housed in a seat at a seating position of the occupant via a supporting member; and a load transmission-driving device transmitting a displacement amount of the supporting member, generated in the seating detection portion when the occupant is seated, to the buckle projection mechanism, and driving the buckle projection mechanism, and enabling the tongue to be inserted into the buckle when the occupant is seated.

It is preferable for the seating detection portion to be housed in the seating portion. Therefore, the buckle usually housed in the seating portion so as not to disturb can be operated by the seated occupant in conjunction with a seating operation of the occupant.

It is preferable for the seating detection portion to be housed in the seat back. Therefore, the buckle usually housed in the seat back so as not to disturb can be operated by the seated occupant in conjunction with a seating operation of the occupant.

It is preferable that the supporting member is formed of a wire, and the free end of the wire is displaced in correspondence to the bending amount of the seating detection portion when the load of the occupant is applied to the seating detection portion that is supported by means of the wire, and the buckle of the buckle projecting mechanism is caused to operate utilizing the displacement of the free end of the wire as a driving force. Therefore, there is no need to employ an electric driving mechanism and assured operating mechanism can be provided.

It is preferable to provide a buffering member at a point along the route of the supporting member, and the displacement of the wire due to an external force that is applied to the projected buckle is temporarily absorbed by means of the buffering member. Therefore, even when an unexpected external force is applied to the buckle in a projecting state, an impact can be prevented from being applied to the buckle projection mechanism or the like, and a mechanism can be prevented from suffering damage.

It is preferable that in the buckle projection mechanism, the buckle-supporting portion is rotatably supported, the free end of the wire is coupled with a part of the buckle-supporting portion, the buckle-supporting portion is rotated by means of the driving force, corresponding to the displacement amount of the wire, and the buckle is caused to project from the housing portion in the seat.

It is preferable to provide a projecting state-detection device that detects a state where the buckle is projected from the seating surface by means of the buckle projection mechanism, and transmits the signal, and the information-transmitting device that transmits the information to the outside when the signal transmitted by means of the projecting state-detection device is received. Therefore, the occupant can speed up to wear the seat belt and a wearing rate of the seat belt can be improved.

As described above, according to the present invention, since the load of the occupant seated in the seat can be utilized as the driving force to cause the buckle apparatus to stand up without detecting the seating information of the occupant by means of an electric sensor, an actuator such as a motor is not necessary and a power source or the like is not necessary at all, and a seatbelt buckle apparatus having a significantly simple mechanism can be provided.

### BRIEF DESCRIPTION OF THE DRAWINGS

FIG. 1 is a schematic perspective view illustrating a rear seat in which a seatbelt buckle apparatus of the present invention is installed.

FIG. 2 is a schematic perspective view illustrating a construction of a first embodiment of the seatbelt buckle apparatus of the present invention.

FIG. 3 is a front elevation illustrating the buckle projection mechanism looking from a direction of an arrow III in FIG. 2.

FIG. 4 is a side elevation illustrating the buckle projection mechanism looking from a direction of an arrow IV in FIG. 2.

FIG. 5 is a cross-sectional view of a seating portion of a seat illustrating a housing state of the seating detection portion of the seatbelt buckle apparatus.

FIGS. 6(a) and 6(b) are operation explanatory views illustrating an operating state of the seatbelt buckle apparatus in a first embodiment.

FIG. 7 is a side elevation illustrating a standing-up state of the buckle projection mechanism illustrated in FIG. 4 and incidental equipment thereof.

FIG. 8 is a partial construction view illustrating an example of a buffering member installed in the seatbelt buckle apparatus.

FIG. 9 is a schematic perspective view illustrating a variation of the seating detection portion in the seatbelt buckle apparatus.

FIG. 10 is a schematic perspective view illustrating a rear seat in which the seatbelt buckle apparatus is installed in a manner different from that of FIG. 1.

FIG. 11 is a schematic perspective view illustrating a construction of a second embodiment of the seatbelt buckle apparatus of the present invention.

FIG. 12 is a schematic perspective view illustrating a variation of the second embodiment of the seatbelt buckle apparatus of the present invention.

FIGS. 13(a) and 13(b) are a state explanatory view illustrating a buckle-housing state and a buckle-projecting state illustrated in FIG. 11.

FIGS. 14(a) and 14(b) are operation explanatory views illustrating an operating state of the seatbelt buckle apparatus in the second embodiment.

### DETAILED DESCRIPTION OF PREFERRED EMBODIMENTS

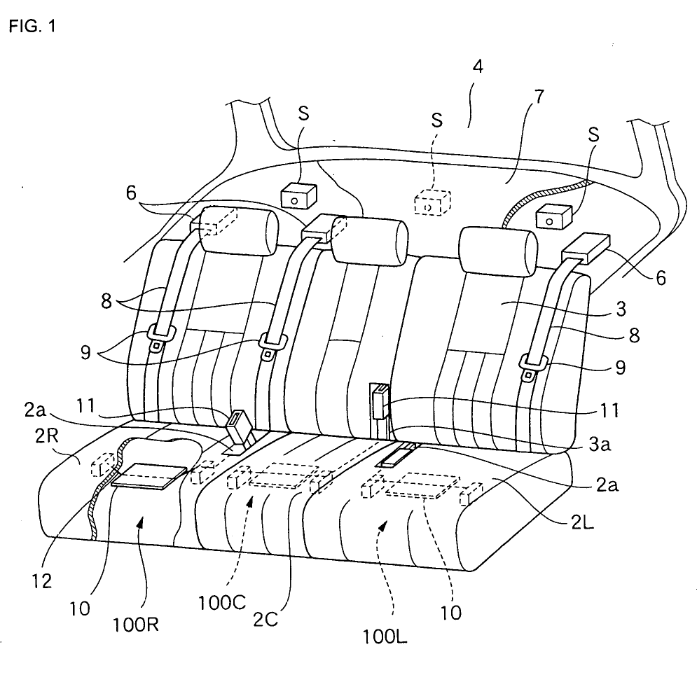

Hereinbelow, a seatbelt buckle apparatus according to the present invention will be explained with reference to two embodiments illustrated in FIG. 1 through FIG. 7.

### First Embodiment

Seatbelt buckle apparatuses 100 of the present invention are housed inside seating portions 2L and 2R for occupants seated on the left and right door sides and a back portion 3C at a center of a seat in the seating portion 2 of a rear seat 1 as a triple seat of a vehicle, as illustrated in FIG. 1. In the first embodiment, a construction of a buckle apparatus, in which a buckle 11 housed in a cut-open portion 2a of the seating portion 2 stands up when the occupant on the left or right position is seated, and the buckle 11 is used in that state, will be explained. In the second embodiment, a construction of a buckle apparatus, in which the buckle 11 housed in a cut-open portion 3a provided in a part of a seat back 3 is projected in such a way that the buckle 11 is caused to fall forward, when the occupant is seated on the center of the rear seat 1, will be explained.

### Construction of the Seatbelt Buckle Apparatus in the First Embodiment

FIG. 1 is a schematic perspective view of the rear seat illustrating a part of a rear shelf 7 between the seat back 3 of the rear seat 1 and a rear window 4, and a part of the seating portion 2 of a right side seat while cutting open for convenience of explanation. In the three seatbelt apparatuses, as illustrated in FIG. 1, a retractor 6 is fixed to a frame (not illustrated) below the rear shelf 7, a seatbelt 8 withdrawn from the retractor 6 is withdrawn to a lower end of the seat back 3 along the seat back 3, and an end portion thereof is fixed to an anchor portion (not illustrated) that is positioned at a back portion between the lower end of the seat back 3 and the seating portion 2. In each seatbelt 8, a tongue 9 is inserted and is disposed at a height for the occupant to easily pick up by mans of a not-illustrated snap member that is provided in the seatbelt 8.

In FIG. 1, a seatbelt buckle apparatus 100R on a right seat imaginarily illustrates a state where a not-illustrated occupant is seated, and a seatbelt buckle apparatus 100L on a left seat illustrates a normal state where the occupant is not seated. As described above, since the right seat is in a state where the buckle 11 stands up from a seating surface, the occupant on the right seat (not illustrated) can withdraw the seatbelt 8 from the retractor 6 in a state of being seated, by the tongue 9 located at an intermediate position of the seatbelt 8, as a key, insert the tongue 9 into the insertion hole of the buckle 11 in a state of standing up from a seating surface on the left side of the seated seat, and easily wear the seatbelt 8.

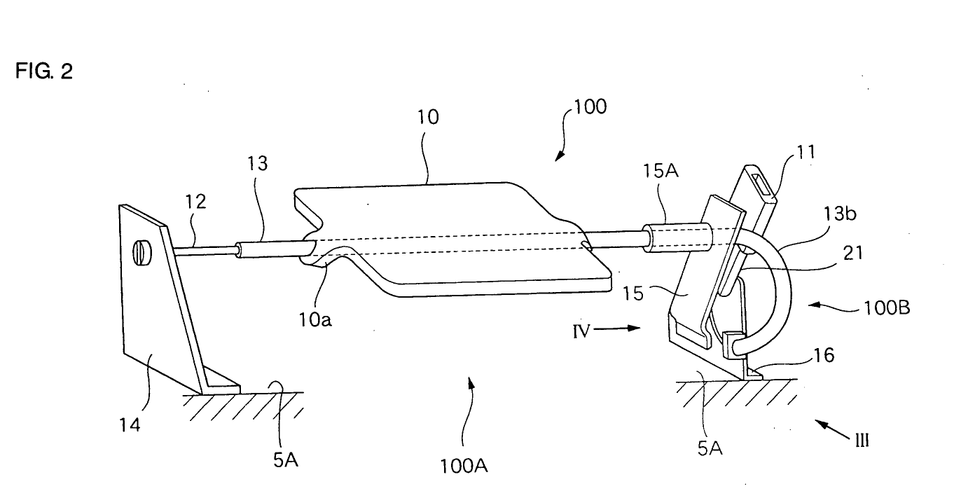

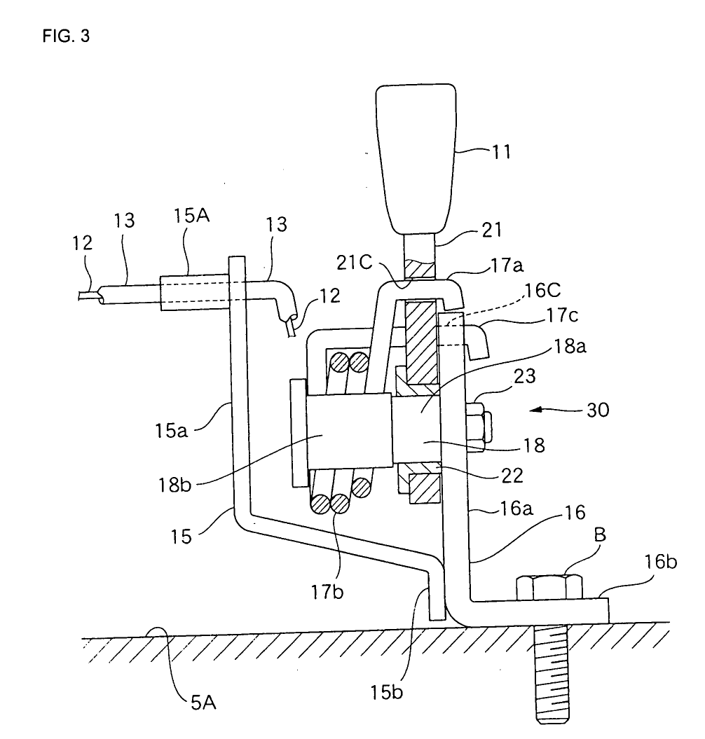

The seatbelt buckle apparatus 100 (hereinbelow, the seatbelt buckle apparatus 100R will be explained as an example, and the mark R is omitted from the reference numeral 100R.) is constructed of a seating detection portion 100A and a buckle projection mechanism 100B, as illustrated in FIG. 2 where an entire construction is illustrated. As for the seating detection portion 100A, one end is supported by a wire-fixing stay 14, and the other end is supported by a guide stay 15, and the buckle projection mechanism 100B is fixed to a frame 5A in a seat via a buckle bracket 16 with a fixing device such as a bolt B (in FIG. 3) or the like. Incidentally, in the present embodiment, the guide stay 15 is fixed on a side surface of the buckle bracket 16, as described later. Accordingly, an entire seatbelt buckle apparatus 100 is fixed and supported to the frame 5A in the seat by means of the wire-fixing stay 14 and the buckle bracket 16.

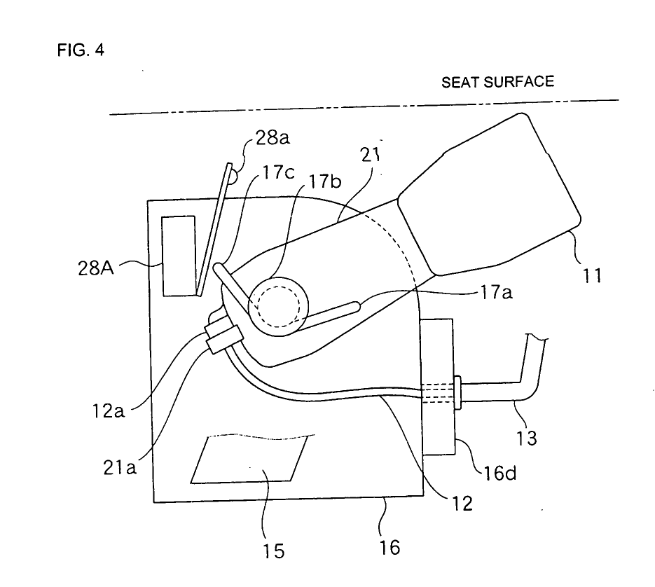

The seating detection portion 100A is formed of a construction in which a wire 12 is stretched between the wire-fixing stay 14 and the guide stay 15 having an approximately L-shape in a side view, which is fixed to a side surface of the buckle bracket 16, as illustrated in FIG. 2 and FIG. 3. The wire 12 is configured such that one end is fixed to the wire-fixing stay 14, and a stretched entire area is generally covered by a wire cover 13. The wire cover 13 is formed of a resin-made tube for covering the wire 12, and the wire 12 penetrates a supporting tab 10a provided in a seating detection plate 10, holds the seating detection plate 10, and holds the seating detection plate 10 at an occupant-seating position. Further, the wire cover 13 usually has a corrosion control function for the wire 12, and also serves as a sheath enabling a free end 12a (in FIG. 4) to be smoothly displaced when the wire 12 is bent.

Currently, a construction and operation of the seating detection portion 100A will be explained with reference to FIG. 2 and FIG. 3. In the seating detection plate 10 illustrated in FIG. 2, a flexible polypropylene resin-molded plate having a plane surface of 160 by 100 mm in square, and a thickness of about 3 mm is used. The seating detection plate 10 is supported by the wire 12 serving as a supporting member horizontally stretched between the wire fixing stay 14 and the guide stay 15 via the supporting tab 10a provided at a center position on a short edge side, and via the wire cover 13. At this moment, a predetermined rigidity is required for the wire-fixing stay 14, the buckle bracket 16, and the guide stay 15 so as not to be displaced or deformed in a state that the occupant is seated. Specifically, at a supporting portion on a side of the guide stay 15, a bush 15A is fitted and thereby the rigidity is added so that the wire 12 can smoothly be inserted in this portion.

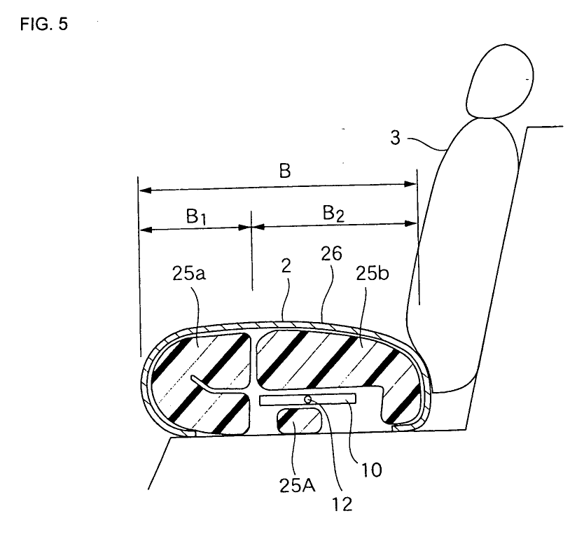

The thus supported seating detection plate 10 is constructed such that although the plate itself is bent corresponding to a body weight of the occupant seated in the seating portion 2 (in FIG. 5), as described later, the wire 12 where the seating detection plate 10 is supported is also bent. Although it depends on the body weight of the occupant, the seating detection plate 10 is sunk down to an extent from about 40 to about 50 mm in conjunction with a seat cushion 25 (in FIG. 5) described later. The free end 12a (in FIG. 4) of the wire 12 supporting the seating detection plate 10 is drawn into a side of the wire cover 13 by a predetermined amount corresponding to a sinking (hollowing) amount of the seating detection plate 10. The wire 12 can be bent to have a smooth suspension shape without being accompanied by an elastic stretch between the wire-fixing stay 14 and the guide stay 15 by an extent of the drawn amount.

Next, a construction and an operation of the buckle projection mechanism 100B will be explained with reference to FIG. 3 and FIG. 4. FIG. 3 is a front elevation of the buckle projection mechanism 100B looking from a direction of an arrow III in FIG. 2. In the same FIGS. 3 and 4, in order to illustrate a construction of a buckle-supporting portion 30, illustration of the wire cover 13 positioned on the front side is omitted. In the buckle-supporting portion 30, as illustrated in the same FIGS. 3 and 4, a base flange 16b of the buckle bracket 16 having an approximately L-shape is fixed to the frame 5A in the seat by a bolt B. On the other hand, at a lower portion of a buckle-rotatably supporting flange 16a of the buckle bracket 16, a lower end 15b of the guide stay 15 is fixed. Between a supporting flange 15a of the guide stay 15 and the buckle-rotatably supporting flange 16a, a buckle-driving shaft 18 is fixed to the buckle-rotatably supporting flange 16a in a horizontal manner via a nut 23 that is screwed onto a shaft end screw. Incidentally, in replacement of the frame 5A in the seat to which the base flange 16b is attached, a part of an existing structural member such as a floor pan (not illustrated) or the like is also preferable to be attached.

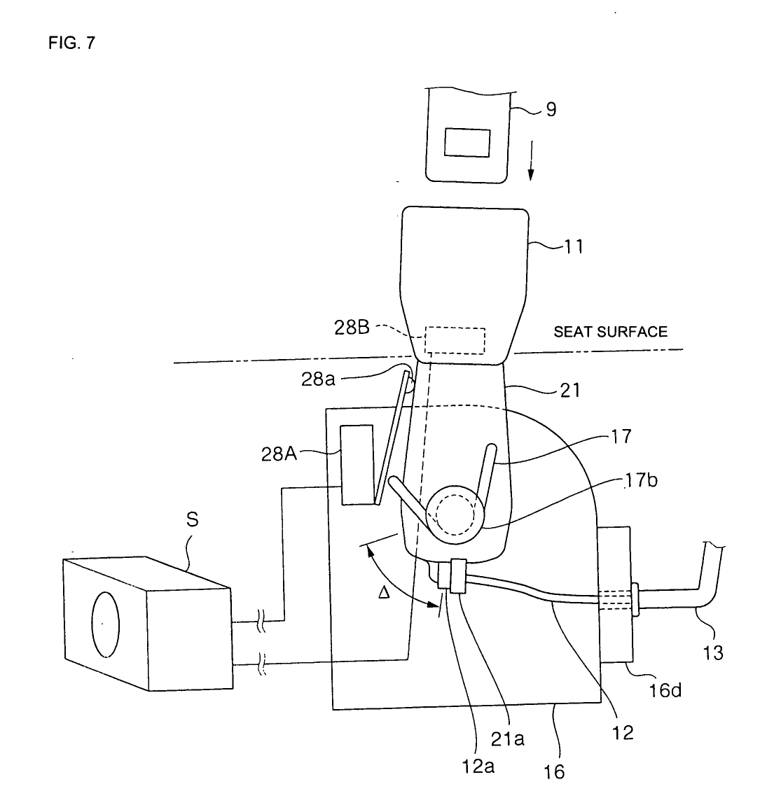

The buckle 11 to which the tongue 9 is inserted and held is supported by a buckle plate 21, and by means of a rotation of the buckle plate 21 around the buckle-driving shaft 18 of the buckle plate 21 serving as a fulcrum, and the buckle plate 21 can be rotated at a predetermined angle between a position of a housing state (in FIG. 4) and a position of a standing up state (in FIG. 7). The buckle-driving shaft 18 is composed of a two-step shaft portion of a small diameter portion 18a where a collar 22 that rotatably supports the buckle plate 21 is fitted upon, and a large diameter portion 18b where a coil portion 17b of a return spring 17 that applies a rotation force to the buckle plate 21 is held. In the buckle plate 21, a buckle 11 is coupled with an upper end thereof, and an end portion 12a of the wire 12 is fixed to a wire fixing portion 21a provided at a lower end of the buckle plate 21. Further, by means of the wire 12 that is drawn into the wire cover 13 by a seating operation of the occupant, the buckle plate 21 is rotated around the buckle-driving shaft 18, and the buckle 11 can stand from a housing place in the seating portion 2 (refer to FIG. 3 and FIG. 7).

As for the return spring 17 where the coil portion 17b is held by the large diameter portion 18b, an end 17a is inserted into a fixing hole 21c formed in the buckle plate 21 and fixed, the coil portion 17b having a predetermined winding number is held by the large diameter portion 18b of the buckle-driving shaft 18, and the other end 17c is inserted into a fixing hole 16c formed in the buckle-rotatably supporting flange 16a and fixed (refer to FIG. 3), while a state (in FIG. 4) where the buckle plate 21 is housed in the not-illustrated seating portion 2 forms an initial state. Furthermore, a detection switch 28A serving as a sensor that detects a projecting state (standing up state) of the buckle plate 21 is attached to an upper end of the buckle-rotatably supporting flange 16a, and it is configured that the standing up state of the buckle plate 21 can be confirmed with a detection contact piece 28a, and later—described information, can be sent out.

Currently, a wiring state of the wire 12 that is stretched between the seating detection portion 100A and the buckle projection mechanism 100B will be explained with reference to FIG. 2, FIG. 3, and FIG. 4. The wire 12 extended from a side of the guide stay 15 passes through an inside of an approximately U-shaped wire cover 13b (in FIG. 2), and is pulled out from the wire cover 13 via a wire guide portion 16d provided at an end portion of the buckle-rotatably supporting flange 16. The wire 12 is fixed to the wire-fixing portion 21a provided at an end (lower end) opposite of a side where the buckle 11 of the buckle plate 21 is attached. A length of the wire 12 is set such that the wire 12 has a horizontal straight line shape at an installation position of the seating detection plate 10, as illustrated in FIG. 2, and the buckle plate 21 can be fixed to a fixing end 21a of the buckle plate 21 in the initial state illustrated in FIG. 4.

Incidentally, around the seating detection plate 10, a urethane-foam made front seat cushion 25a and a rear seat cushion 25b that are formed into predetermined shapes, respectively, which are packaged in the seating portion 2, are integrally covered by a seat cover 26, as illustrated in FIG. 5, and a seating portion 2 that does not have an uncomfortable feeling when the occupant is seated, is formed. A seat cushion 25A serving as a pillow for the seating detection plate 10 is disposed on a side of a lower surface of the seating detection plate 10. Therefore, in a state where the occupant is not seated, as illustrated in FIG. 2, the seating detection plate 10 disposed below the rear seat cushion 25b is horizontally supported. Thus, by means of the seating detection plate 10 that is disposed below the rear seat cushion 25b, when the occupant only falls on its backside to a front portion of the seating portion 2 when the occupant moves in a lateral direction on a seat, only the front seat cushion 25a is deformed and the rear seat cushion 25b is not deformed, and therefore there is no possibility that the seating detection plate 10 is operated.

Moreover, when the occupant is seated in a predetermined position, the body weight of the occupant causes the rear seat cushion 25b to deform, and the seating detection plate 10 disposed below the rear seat cushion 25b is sunk down together with the deformation of the rear seat cushion 25b. On the other hand, when the occupant floats a waist upward for leaving the seat, the seating detection plate 10 disposed below the rear seat cushion 25b elastically returns to the former shape from a bent shape to an original flat shape along with a recovering deformation of the rear seat cushion 25b. At this moment, as for a rate of the front seat cushion 25a and the rear seat cushion 25b, when a length of the front seat cushion 25a is defined as B1, and a length of the rear cushion 25b is defined as B2, it is preferable that a response area of the ratio of B1 to B2 is set to be about 1:2, and only when the occupant is seated within the response area, the seating detection plate 10 is operated.

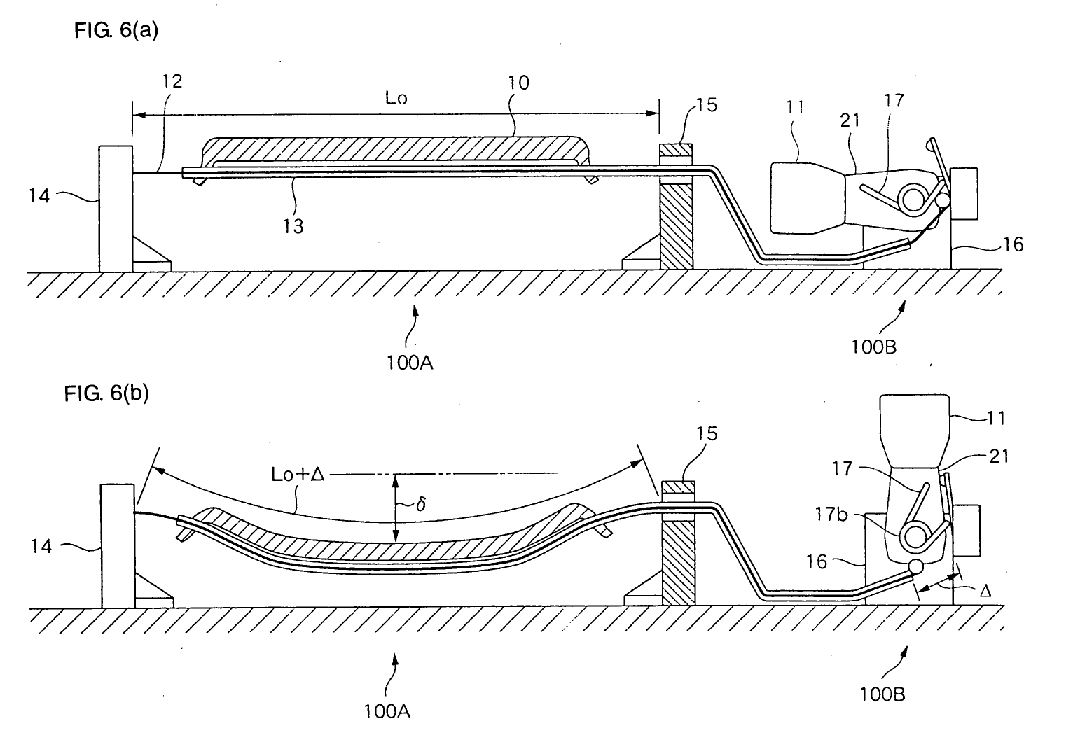

Next, in the seatbelt buckle apparatus 100, operations of the seating detection portion 100A and the buckle projection mechanism 100B corresponding to the operation from the occupant gets on a vehicle until the occupant wears the seatbelt 8 upon being seated in the seating portion 2, and an operation until the occupant gets out the vehicle after unfastening the seatbelt 8 will be explained with reference to FIGS. 6(a) and 6(b). Incidentally, in both FIGS. 6(a) and 6(b), for better understanding of the operation, the guide stay 15 is schematically illustrated as an independent member for supporting the seating detection portion 100A.

In a case that the occupant is not seated, the seating detection plate 10 is held in a horizontal state, as illustrated in FIG. 6(a). A length of the wire 12 between the wire-fixing stay 14 and the guide stay 15 at this moment is defined as L₀. At this moment, the buckle plate 21 is in a state of housed (fallen down) in the seating portion 2 by means of holding a force of the return spring 17 in the initial state.

When the occupant is seated in the seating portion 2, a center portion of the seating detection plate 10 is bent in a sinking down manner by δ due to the body weight of the occupant, as illustrated in FIG. 6(b), and the wire 12 in the wire cover 13, which supports the seating detection plate 10, also curves along with the seating detection plate 10. The length of the wire 12 located between the wire-fixing stay 14 and the guide stay 15 becomes (L₀+Δ) depending on a bending amount δ. That is, the wire 12 located between the wire-fixing stay 14 and the guide stay 15 is bent to have the suspension shape by an amount drawn from an outside of the guide stay 15 by the amount Δ from the length before the occupant is seated. At this moment, the free end 12a on a side of a wire-fixing end of a side of the buckle plate 21 is drawn into the wire cover 13 by the amount Δ, and the buckle plate 21 is rotated around the buckle-driving shaft 18 while being biased in a direction for increasing a winding force of the coil portion 17b of the return spring 17 by the amount Δ of the reduced length of the wire 12 in such a way that a state of the buckle plate 21 is changed from that in FIG. 4 to that in FIG. 7. Therefore, the buckle 11 coupled with the buckle plate 21 is projected from the seating surface by a predetermined projecting amount in a manner to stand up (in FIG. 6(b) and FIG. 7).

When getting out the vehicle, the occupant unfastens the seatbelt 8, and leaves from the seating portion 2. When the occupant floats its waist upward from the seating surface 2, the seating detection plate 10 is released from a load due to the body weight of the occupant. Consequently, the seating detection plate 10 supported by means of the lower seat cushion 25A returns to the original horizontal and flat shape by an elastic returning deformation of the seating detection plate 10 itself and resilience of the seat cushion 25. Therefore, the length of the wire 12, drawn by the amount Δ, between the wire-fixing stay 14 and the guide stay 15 returns to L₀, and the length of the wire 12 between the guide stay 15 and the fixing end of the buckle plate 21 returns to the length before the occupant is seated. At this moment, by means of restraint of the wire 12 that is released, a biasing force for winding the coil portion 17b of the return spring 17 installed on the buckle plate 21 is released, and the buckle plate 21 returns to the state where the buckle plate 21 is caused to fall over before the occupant is seated, as illustrated in FIG. 4 and FIG. 6(a). Therefore, the buckle 11 is again housed in the inside of the seating portion 2.

As described above, in the seatbelt buckle apparatus 100 according to the first embodiment, since the buckle 11 is projected on a front face of the seating portion 2 only when the occupant is seated in the seating portion 2, there is no possibility that the body of the occupant comes into contact with the buckle 11. Further, a trouble for the occupant to look for the buckle 11 is saved. Furthermore, in this seatbelt buckle apparatus 100, since an actuator such as a motor or the like is not used for rotating the buckle plate 21, it is advantageous in cost. In addition, the wire 12 is drawn and the buckle plate 21 is rotated by the force applied to the seating detection plate 10 by means of seating of the occupant in the seating portion 2, and therefore there is no need to judge whether a predetermined operation has to be applied to the buckle plate 21 using an electric sensor for detecting the seating of the occupant. As a result, the seatbelt buckle apparatus 100 according to the first embodiment is high in reliability, and advantageous in cost.

Incidentally, a seating detection portion is necessary to be configured such that a buckle can be projected from a front face of the seating portion 2 when a body weight of a child is detected, or when a child seat is fixed to a seat using a seatbelt, other than when an adult occupant having an average body weight is seated. Accordingly, it is preferable to set a sensitivity of the seating detection portion in consideration of various seating states of the occupant and a setting state of a fail-safe, such as the child seat or the like.

Next, an operation at a time when a buckle is operated by means of a detection switch will be explained. As illustrated in FIG. 7, when the occupant is seated in a seat and the buckle 11 is caused to stand up from a seating surface in a projecting manner, a part of the buckle plate 21 comes into contact with the detection contact piece 28a of the detection switch 28A, and the detection switch 28A is changed from OFF to ON. At this moment, when the detection switch 28A and an external device are connected, the external device, such as a warning device S, or the like can be driven by the occupant being seated in the seat.

For example, as illustrated in FIG. 7, the warning device S (in FIG. 1) disposed below the rear shelf 7 and a detection switch 28B in the buckle 11 are connected, and the warning device S and the detection switch 28A are connected. The detection switch 28B is turned ON when the tongue 9 is latched on the buckle 11 as illustrated in FIG. 7, and an insertion-completion signal is transmitted to the warning device S. The warning device S is set such that the warning device S is powered ON when the warning device S obtains a signal that is transmitted by the detection switch 28A, and sends a warning beep or a message, and when the warning device S obtains a signal that is transmitted by the detection switch 28B, the warning device S is turned OFF.

As a concrete operation, for example, in FIG. 1 and FIG. 7, the occupant is seated in the seating portion 2, and the above-described buckle projection mechanism is operated, and the buckle 11 is projected on the front face of the seating portion 2. The detection switch 28A is turned ON at this timing and transmits a signal to the warning device S. The warning device S obtains a signal transmitted by means of the detection switch 28A, and the power is turned ON and the warning device S transmits the warning beep or a message for inducing wearing of the seatbelt. Therefore, when the occupant withdraws the seatbelt 8 and inserts the tongue 9 into the buckle 11, and the seatbelt 8 is latched, the detection switch 28B is powered ON and transmits the insertion-completion signal to the warning device S. The warning device S, which is sending out the warning beep or the message, obtains a signal transmitted by the detection switch 28B, the power is turned OFF, and the warning beep or the message is stopped to be sent out.

In this embodiment, although the warning device S is used, it is natural that a warning lamp, other device that generates a warning vibration or the like may be used.

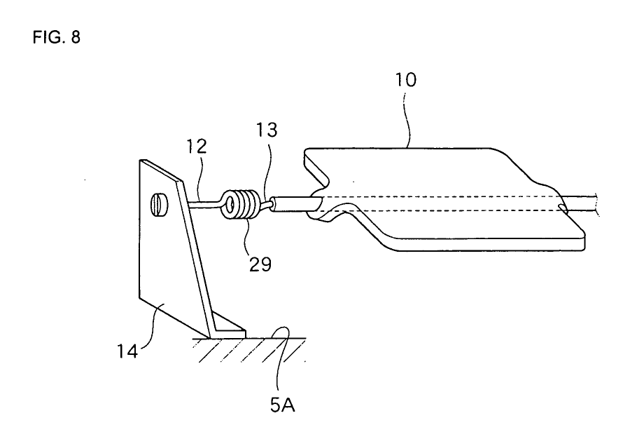

FIG. 8 illustrates a state that, in the seating detection portion 100A illustrated in FIG. 2, a coil spring 29 serving as a buffering member on a side of the wire-fixing stay 14 for the wire 12 horizontally stretched between the wire-fixing stay 14 supporting the seating detection plate 10 and the guide stay 15 is fixed to a part in an axial direction of the wire 12. The coil spring 29 serving as the buffering member is operated as a buffering member to avoid an impact force to be added to a supporting member, in a case that, for example, the buckle apparatus is pushed down by another occupant without discretion, or that a package is placed on the seat in a state that the buckle-projection mechanism (not illustrated) functions and the buckle is caused to stand up.

The seating detection plate 10 has a construction such that, as illustrated in FIG. 6(b), the seating detection plate itself is bent corresponding to the body weight of the occupant seated in the seating portion 2 (in FIG. 1), and in addition, the wire 12 by which the seating detection plate 10 is supported is drawn by the amount Δ. Accordingly, when an external force to push down the buckle 11 is applied in a state where the occupant is seated (a state that the buckle is caused to stand up), the external force is applied to the wire 12 as a rapid drawing force. As a result, a rapid tension occurs in the wire 12 against the weight of the occupant seated in the seat, a large load is applied to the fixing portion of the wire 12 or the seating detection plate 10, or a phenomenon such as that the seating detection plate 10 is lifted upward in the state where the occupant is seated in the seat occurs. Thus, the uncomfortable feeling may also occur in the occupant. Consequently, as illustrated in FIG. 8, the coil spring 29 serving as a buffering member is provided on a wire line of the stretched wire 12. Therefore, even when such an impact force (external force) that rotates the buckle 11 in a housing direction for housing the buckle 11 when the occupant is seated is inputted, and the external force is applied to the buckle projection mechanism 100B and the seating detection portion 100A through the wire 12, since the coil spring 29 is elastically deformed by a predetermined extending amount, and absorbs the impact, there is no possibility that an excessive load is added to each of the supporting members, or the uncomfortable feeling is applied to the occupant.

Incidentally, as a mechanical characteristic of the buffering member, it is preferable to set a spring strength of the coil spring 29 to such an extent that a spring deformation is not caused in a case other than that when the load of the occupant is applied to the buckle 11 (a state that the occupant erroneously seated on a buckle 11 being caused to stand up), whereas a spring strength of the return spring 17 (the spring that is biasing the buckle 11 in the housing direction) is weakened in such an extent that, for example, the housed buckle 11 can be pulled out while lightly picking up.

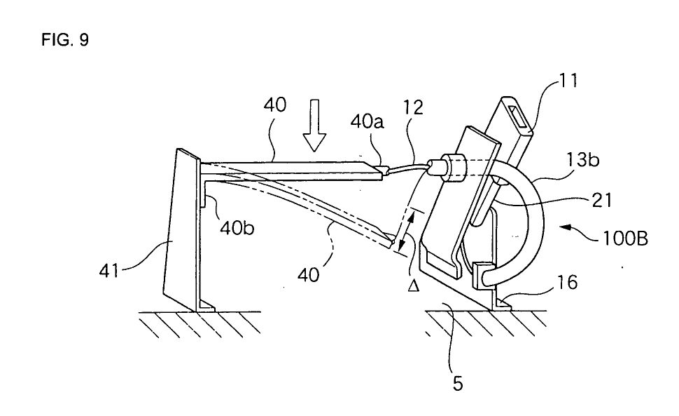

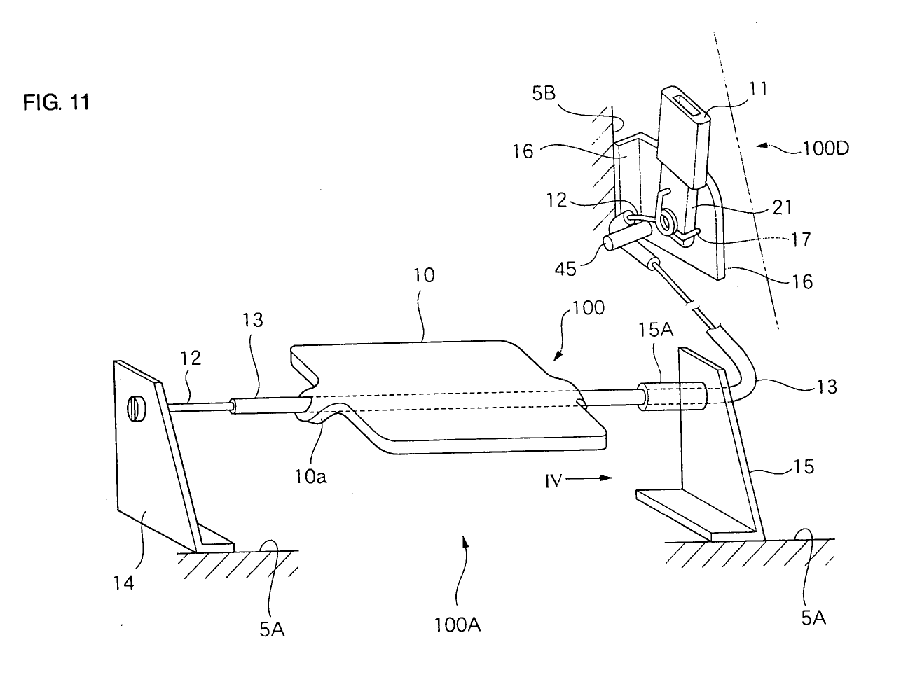

FIG. 9 is a view illustrating a variation of the seating detection plate 10 illustrated in FIG. 2. In this variation, in replacement of the seating detection plate 10 (in FIG. 11) having a shape that supports an entire seating surface for the occupant, a cantilever beam-shaped detection-bending plate 40 whose tip end of the beam is bent while following a deformation of the seat cushion 25b is used. This detection-bending plate 40 is formed of a thin-plate shaped beam member in which a fixing end 40b is fixed to an upper end of the supporting frame 41. This detection-bending plate 40 is housed in a not-illustrated cut-open portion in the seat cushion 25b (refer to FIG. 5), and is bent by a predetermined amount (for example, at a position indicated by a chain double-dashed line) while following the deformation of the seat cushion 25b along with a seating operation of the occupant. In this embodiment, in consideration of durability of the material for a repetition of bending, a belt-shaped steel plate is used.

As other material, a plate member formed of a synthetic resin plate member such as a polypropylene resin or the like capable of securing the durability and the bending-rigidity, various engineering plastics, a carbon fiber-reinforced resin or the like can be used. An end portion of the wire 12 is fixed to a free end (tip end) 40a of the detection-bending plate 40 in a similar construction as illustrated in FIG. 2. The other end of the wire 12 is led to the buckle projection mechanism 100B having a similar construction as that illustrated in FIG. 2. Accordingly, a bending amount of the free end of the detection-bending plate 40 matches the drawn amount Δ of the wire 12, and a portion of the buckle 11 that is supported by the buckle plate 21 can be caused to stand up at a predetermined angle by means of a drawing operation of the wire 12 as illustrated in FIGS. 6(a), 6(b) and FIG. 7, and can be projected from the seating surface. Since the seating detection portion that is housed in the seat cushion can have a compact size compared to the seating detection plate 10, this variation is suitable to a case of installing in a rear seat of a compact car or the like.

### A Construction of the Seatbelt Buckle Apparatus in the Second Embodiment

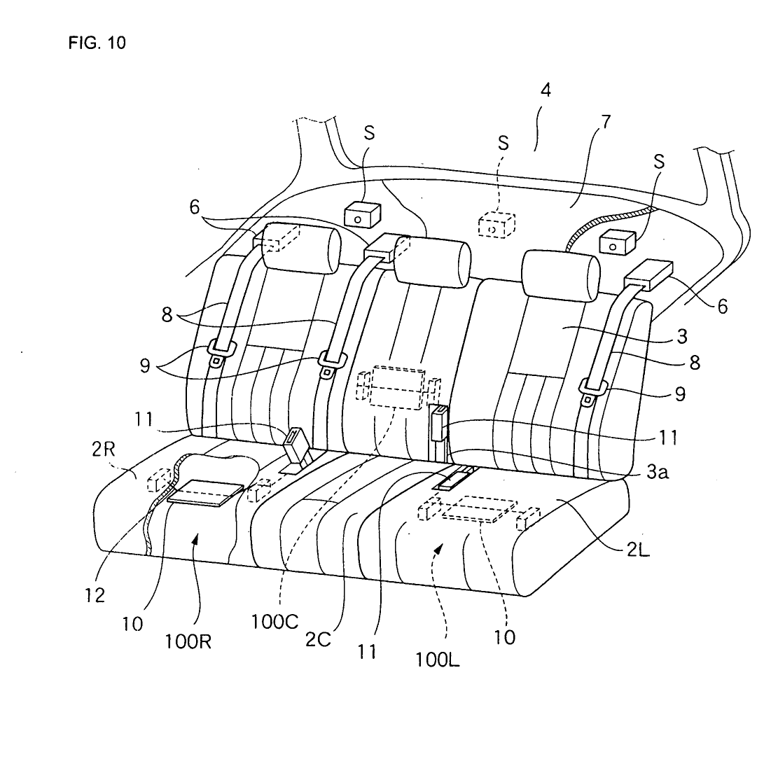

In the second embodiment, a construction of a buckle apparatus, in which the buckle 11 housed in the cut-open portion 3a provided in a part of the seat back 3 is projected in such a way that the buckle 11 is caused to fall forward, when the occupant is seated on the center of the rear seat 1 will be mainly explained. In FIG. 10, a state in which a seating detection portion 100C is installed in the seat back 3 of a center seat in the rear seat is illustrated. Other than the above-described, a construction of the left and right seats is identical to that in FIG. 1.

In FIG. 10, in the seatbelt buckle apparatus 100C in the center seat, a buckle-housing state in which the occupant is not seated is illustrated. From this state, when the occupant is seated, the buckle 11 housed in the cut-open portion 3a provided in the seat back 3 is projected in such a way that the buckle 11 is caused to fall forward by a predetermined angle. In this state, the occupant can withdraw the seatbelt 8 from the retractor 6 by the tongue 9 located at the intermediate position of the seatbelt 8, as a key, which is positioned on the right side, insert the tongue 9 into the insertion hole of the buckle 11 that is in the state of being caused to stand up from the seating surface on the left side of the seated seat, and easily wear the seatbelt 8.

FIG. 11 illustrates a construction of the seatbelt buckle apparatus 100C. The seatbelt buckle apparatus 100C is constructed of the seating detection portion 100A and a buckle projection mechanism 100D. In the first embodiment (refer to FIG. 2), the seating detection portion 100A and the buckle projection mechanism 100B constituting the seatbelt buckle apparatus 100 is firmly fixed and supported onto the frame 5A in the seat (fixing portion) with the wire-fixing stay 14 and the buckle bracket 16. In contrast, in the second embodiment, the buckle projection mechanism 100D is firmly fixed and held to a frame 5B in the seat back via the base flange 16b of the buckle bracket 16 with a bolt (not illustrated). Since the construction is made as described above, although the seating detection portion 100A has an approximately the same construction as that illustrated in FIG. 2, the guide stay 15 holding an end of the wire 12 is independently fixed to the frame 5A in the seat. The shape of the guide stay 15 is the same as that of the wire-fixing stay 14, which is approximately symmetric therewith, as illustrated in FIG. 11. Since the construction of the seating detection plate 10 is the same as that illustrated in FIG. 2, an explanation of the construction will be omitted.

A driving mechanism for causing the buckle plate 21 of the buckle projection mechanism 100D to fall has approximately the same shape as the shape in which the guide stay 15 is removed from the buckle projection mechanism 100B illustrated in FIG. 3, and is also common in function in terms of drawing operation of the wire 12 against a biasing force of the return spring 17. Since the buckle projection mechanism 100D is firmly fixed and held to the frame 5B in the seat back 3, as illustrated in FIG. 11, a wiring of the wire 12 that is extended from the guide stay 15 up to the buckle projection mechanism 100D is further extended from the seat 2 up to a lower end position of the seat back 3.

Further, in order to realize a falling over operation of the buckle plate 21 by means of a draw of the wire 12, the wire 12 that is inserted into the wire cover 13 is diverted by means of the wire guide 45. That is, the wire 12 turns around a position of a round bar-shaped wire guide 45 that is protruded on a side surface of the buckle bracket 16 in a state of being inserted into the wire cover 13, and is fixed to the lower end of the buckle plate 21. In this state, when the occupant is seated in the seat, as described later, the wire 12 is drawn in a direction for causing the buckle plate 21 to fall against the return spring 17 that is installed so as to house the buckle plate 21 in the seat back 3, and the buckle 11 is exposed from the cut-open portion 3a of the seat back 3. Incidentally, by means of providing a diverting member such as a pulley, or the like in replacement of the wire guide 45, it is also applicable to change over a drawing direction of the wire 12, when the wire 12 itself is drawn.

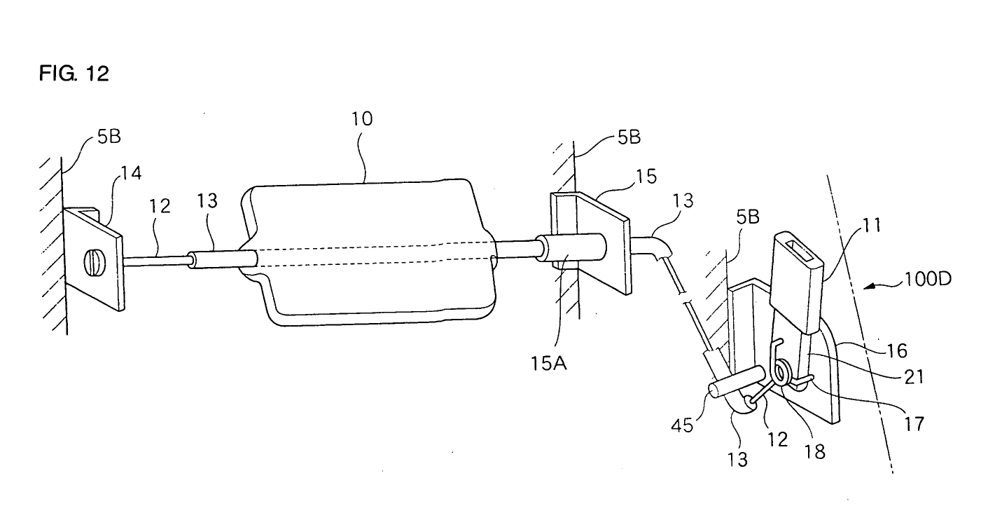

FIG. 12 is a perspective view illustrating a variation where the same construction as that of the seating detection portion 100A illustrated in FIG. 11 is installed in the seat back 3 in the second embodiment. In the seating detection portion 100A, the wire-fixing stay 14 and the guide stay 15 are firmly fixed to the frame 5B in the seat back. The seating detection plate 10 is positioned on a lower side (back side) of a cushion at a front face, along inclination of the seat back (not illustrated), and when the occupant is seated, and leans against the seat back 3, the cushion is caved and the seating detection plate 10 is bent. At this moment, the buckle 11 can be projected from the cut-open portion (not illustrated) of the seat back 3 by causing the buckle plate 21 of the buckle projection mechanism 100D to fall over corresponding to the drawing amount of the wire 12 that supports the seating detection plate 10. At this moment, the seating detection portion 10 is configured to be easily bent compared to a case of being disposed at the seating position (for example, in FIG. 2 and FIG. 11), by means of adjusting a thickness, a shape, a bending rigidity, or the like of the seating detection portion 10. Furthermore, an attaching position is preferably set to a lower portion of the seat back 3 where the occupant contacts, when the occupant is seated at a proper position.

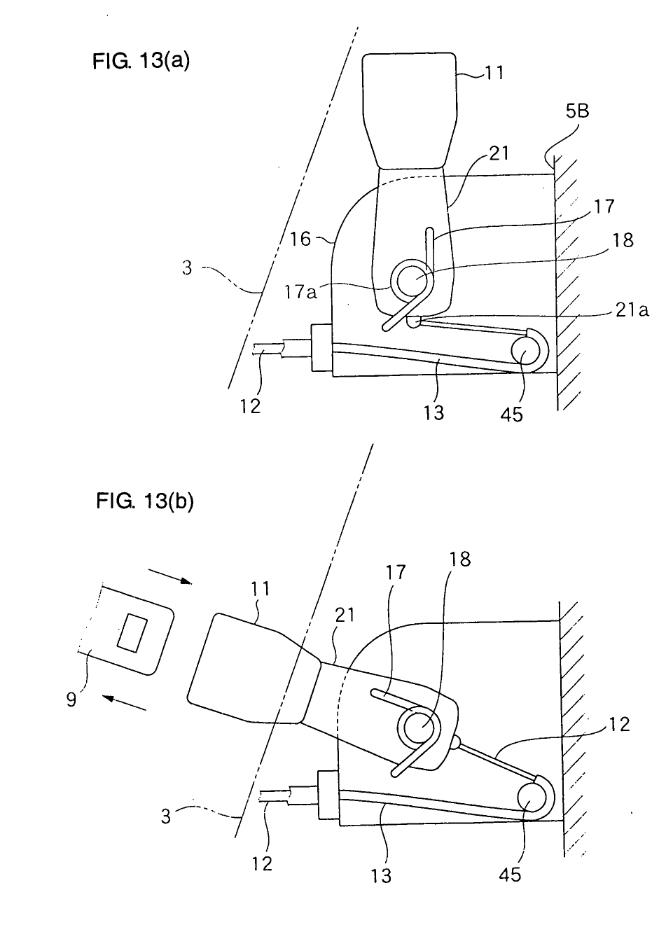

Next, a schematic construction and an operation of the buckle projection mechanism 100D will be explained with reference to FIGS. 13(a) and 13(b). FIG. 13(a) illustrates a buckle-housing state, and FIG. 13(b) illustrates a buckle-projecting state. The buckle bracket 16 serving as a supporting body for the buckle projection mechanism 100D has an approximately L-shape as illustrated in FIG. 11 and FIG. 12, and the base flange 16b is fixed to the frame 5B in the seat back with a bolt (not illustrated). The buckle 11 into which the tongue 9 (FIG. 13(b)) is inserted and held is supported by the buckle plate 21, and by means of a rotation of the buckle plate 21 around the buckle-driving shaft 18 as the fulcrum, the buckle plate 21 is rotated by a predetermined angle between the buckle-housing state (in FIG. 13(a)) and the buckle-projecting state (in FIG. 13(b)). The coil portion 17b of the return spring 17 that applies the rotation force to the buckle plate 21 is held by the shaft portion of the buckle-driving shaft 18.

An attaching construction of the return spring 17 is approximately the same as that of the buckle projection mechanism 100B of a seating portion-installation type illustrated in FIG. 3 and FIG. 4. In the buckle plate 21 where the buckle 11 is coupled with an upper end thereof, an end portion of the wire 12 is fixed to the wire-fixing portion 21a at a lower end. By means of the wire 12 being drawn by the seating operation of the occupant, the buckle plate 21 can be rotated around the buckle-driving shaft 18 and the buckle 11 can be projected from the inside of the cut-open portion 3a of the seat back 3 (refer to FIG. 13(b)).

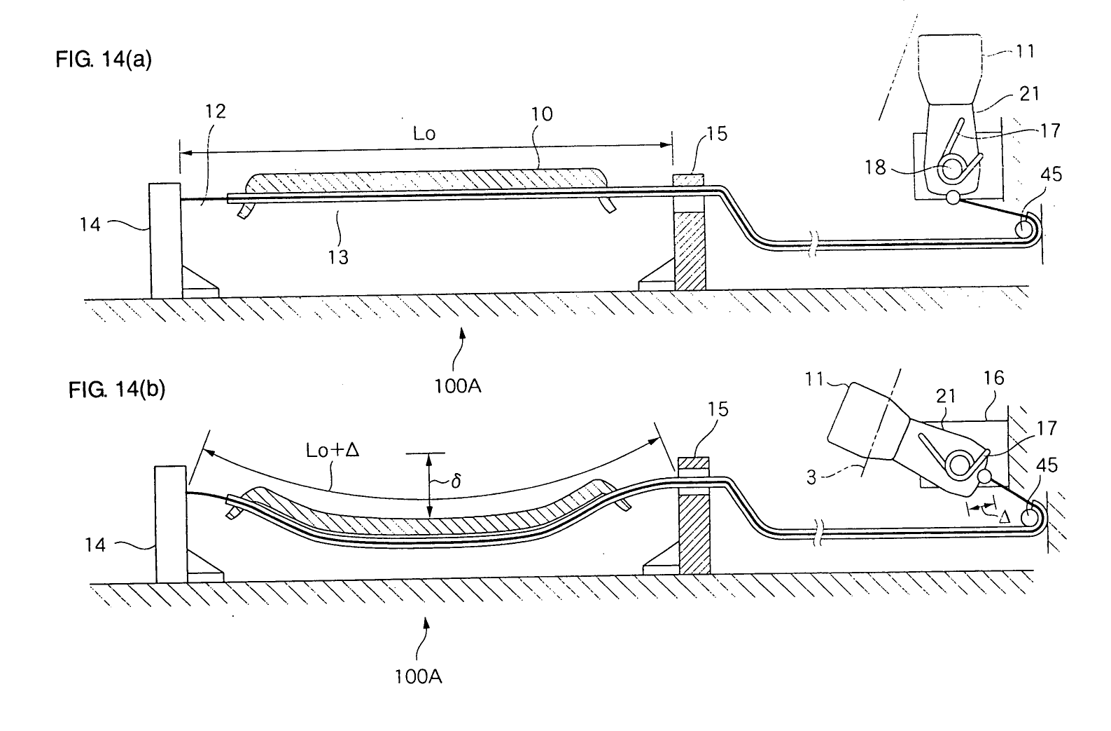

Currently, a wiring state of the wire 12 that is stretched between the seating detection portion 100A and the buckle projection mechanism 100D will be explained with reference to FIGS. 14(a) and 14(b). The wire 12 that is extended from a side of the guide stay 15 supported by means of the frame 5A in the seat turns around the wire guide 45 while passing through the wire cover 13b (in FIG. 2), and is fixed to the wire-fixing portion 21a at the lower end of the buckle plate 21. A length and a wiring route of the wire 12 are appropriately set in conjunction with the situation whether the seating detection portion 100A is provided in the seating portion or is installed in the seat back 3.

Next, in the seatbelt buckle apparatus 100, an operation of the seating detection portion 100A and the buckle projection mechanism 100D corresponding to the operation of the occupant from a time when the occupant gets on a vehicle to a time when the occupant wears the seatbelt 8 after being seated in the seating portion 2, and an operation of the occupant from a time when the occupant unfastens the seatbelt 8 and gets out the vehicle, will be explained with reference to FIGS. 14(a) and 14(b).

In a case that the occupant is not seated in the seating portion 2, the seating detection plate 10 is held in a horizontal state as illustrated in FIG. 14(a). The length of the wire 12 between the wire-fixing stay 14 and the guide stay 15 at this moment is L₀. The buckle plate 21 at this moment is in-a state of being housed (caused to stand up) in the seat back 3 by means of a holding force of the return spring 17 in the initial state.

When the occupant is seated in the seating portion 2, the center portion of the seating detection plate 10 is bent in a sinking down manner by δ due to the body weight of the occupant, as illustrated in FIG. 14(b), and the wire 12 in the wire cover 13, which supports the seating detection plate 10, also curves along with the seating detection plate 10. The length of the wire 12 located between the wire-fixing stay 14 and the guide stay 15 becomes (L₀+Δ) depending on a bending amount δ. That is, the wire 12 located between the wire-fixing stay 14 and the guide stay 15 is bent to have the suspension shape by the amount drawn from an outside of the guide stay 15 by the amount Δ from the length before the occupant is seated. At this moment, the free end 12a on a side of a wire-fixing end of a side of the buckle plate 21 is drawn into the wire cover 13 by the amount Δ, and the buckle plate 21 is rotated around the buckle-driving shaft 18 while being biased in a direction for increasing a winding force of the coil portion 17b of the return spring 17 by the amount Δ of the reduced length of the wire 12 in such a way that a state of the buckle plate 21 is changed from that in FIG. 13(a) to that in FIG. 13(b). Therefore, the buckle 11 coupled with the buckle plate 21 is projected from the seating surface by a predetermined projecting amount in a manner so as to fall, and the tongue 9 can be inserted (in FIG. 13(b)).

At a time of getting out the vehicle, when the occupant unfastens the tongue 9 of the seatbelt (in FIG. 13(b)) and the occupant floats the waist upward from the seating portion 2, the seating detection plate 10 is released from the load caused by the body weight of the occupant. Consequently, the seating detection plate 10 that is supported by means of lower seat cushion 25A returns to the original horizontal and flat shape by the elastic returning deformation of the seating detection plate 10 itself and resilience of the seat cushion 25. Therefore, the length of the wire 12, drawn by the amount Δ, between the wire-fixing stay 14 and the guide stay 15 returns to L₀, and the length of the wire 12 between the guide stay 15 and the fixing end of the buckle plate 21 also returns to the length before the occupant is seated. At this moment, by means of restraint of the wire 12 that is released, a biasing force for winding the coil portion 17b of the return spring 17 installed on the buckle plate 21 is released, and the buckle plate 21 returns to the state where the buckle plate 21 is caused to stand up before the occupant is seated, as illustrated in FIG. 13(a) and FIG. 14(a). Therefore, the buckle 11 is again housed in the inside of the seat back 3.

As described above, in the second embodiment, in the seatbelt buckle apparatus 100, since the buckle 11 is projected on a front face from the inside of the seat back 3 only when the occupant is seated in the seating portion 2, there is no possibility that the body of the occupant comes into contact with the buckle 11. Further, a trouble for the occupant to look for the buckle 11 can be saved.

As described above, the seating detection portion 100A can be installed in any of the inside of the seating portion 2 and the inside of the seat back 3, and in conjunction with the above-described, the buckle projection mechanism 100B can be installed in the seating portion 2 and the buckle projection mechanism 100D can be installed in the seat back 3. It is preferable to decide these combinations upon researching a size (width) of the rear seat, a seating pattern of the rear seat corresponding to a type of vehicle, or the like. Incidentally, when the combination is decided, a disposition of the seating detection portion, the buckle projection mechanism (in the seating portion), and the buckle projection mechanism (in the seat back) is necessary to be decided from a designing stage of the inside of the seating portion and the frame of the seat back.

Incidentally, by means of using the coil spring 29 serving as the buffering member illustrated in FIG. 8 in the buckle projection mechanism 100D, the impact force can be prevented from transmitting to each of the mechanisms even in a case that an external force is unexpectedly applied to the buckle 11 that is projected from the cut-open portion 3a of the seat back 3.

The disclosures of Japanese Patent Applications No. 2007-269071 filed on Oct. 16, 2007 and No. 2008-223286 filed on Sep. 1, 2008 are incorporated as a reference.

While the invention has been explained with reference to the specific embodiments of the invention, the explanation is illustrative and the invention is limited only by the appended claims.

What is claimed is:

1. A seatbelt buckle apparatus for attaching a tongue of a seatbelt, comprising:
a buckle projection mechanism having a buckle for receiving the tongue of the seatbelt, said buckle projection mechanism locating the buckle inside a seat when an occupant is not seated, and to stand up from the seat when the occupant is seated;
a seating detection portion for detecting a load of the occupant, housed in the seat at a seating position of the occupant, said seating detection portion having a supporting member; and
a load transmission-driving device transmitting a displacement amount of the supporting member, generated in the seating detection portion when the occupant is seated, to the buckle projection mechanism, and driving the buckle projection mechanism so that the tongue can be inserted into the buckle when the occupant is seated.

2. The seatbelt buckle apparatus according to claim 1, wherein said buckle projection mechanism is configured to project the buckle upwardly or downwardly from the seat.

3. The seatbelt buckle apparatus according to claim 1, wherein the supporting member comprises a wire with a free end, said free end of the wire being displaced according to a bending amount of the seating detection portion when the load of the occupant is applied to the seating detection portion supported by the wire so that the buckle projection mechanism is operated to project upwardly or downwardly.

4. The seatbelt buckle apparatus according to claim 3, wherein said seating detection portion further includes a buffering member connected to the wire so that a displacement of the wire due to an external force applied to a projected buckle is temporarily absorbed by the buffering member.

5. The seatbelt buckle apparatus according to claim 1, wherein the buckle projection mechanism includes a buckle-supporting portion rotatably supporting the buckle, the free end of the wire being coupled with a part of the buckle-supporting portion so that the buckle-supporting portion is rotated by means of a driving force corresponding to the displacement amount of the wire to project the buckle from a housing portion in the seat.

6. The seatbelt buckle apparatus according to claim 1, further comprising:
a projecting state detection device that detects a state where the buckle is projected from a seat surface by means of the buckle projection mechanism, and transmits a signal; and
an information transmitting device that transmits information to outside when the signal transmitted by means of the projecting state-detection device is received.
